(19) United States
(12) Patent Application Publication
(10) Pub. No.: US 2005/0129264 A1
(43) Pub. Date: Jun. 16, 2005

(54) System module

(75) Inventor: Tetsuya Mitsuishi, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/007,701

(22) Filed: Dec. 8, 2004

(30) Foreign Application Priority Data
Dec. 16, 2003 (JP) 2003-417861

(51) Int. Cl. H02K 41/00; G02B 6/26; G03B 13/32

(52) U.S. Cl. 381/396; 310/12; 310/14; 417/410.1; 385/18

(57) ABSTRACT

The system module includes first and second film members stacked to oppose each other with a predetermined gap therebetween, an actuator or a part of an actuator is formed in the predetermined gap, and the first film member is provided with one or more actuators or a part of the one or more actuators and with one or more devices other than the one or more actuators.

### BACKGROUND OF THE INVENTION

1. Field of the Invention

The present invention relates to a system module allowing decrease in size and thickness by forming a plurality of devices on a sheet of a film member.

2. Description of the Related Art

A conventional module is now described, for example, with reference to a flat speaker disclosed in Patent Document 1, Japanese Unexamined Patent Application Publication No. 2001-333493. In the conventional flat speaker, as shown in FIG. 12, a plate-shaped yoke 110 made of an iron plate is provided at the lowermost portion, and a plurality of magnets 112 is attached to the upper surface of the yoke 110.

A vibrating membrane 114 is disposed above the magnets 112, and coils 118 are wound in a whirlpool shape on the vibrating membrane 114 at positions opposing the magnets 112. The outer circumferential portion of the vibrating membrane 114 is supported by a frame-shaped spacer 120 with a predetermined gap from the magnets 112.

In the conventional flat speaker assembled as a single module, magnetic flux generated from the coils 118 by applying current thereto acts on the magnetic flux of the magnets 112, and a vibrating force in a direction approaching and receding from the magnets 112 is generated in the coils 118.

The vibrating membrane 114 vibrates due to the vibrating force generated in the coils 118, thereby generating sounds.
[Patent Document 1] Japanese Unexamined Patent Application Publication No. 2001-333493

However, since, for example, the flat speaker as the conventional module is built in audio instruments, etc., unlike a printed circuit board mounted with other circuit components, the number of components is increased, which makes the assembling complicated.

For example, in the flat speaker as the conventional module, since the magnets 112 are mounted on the yoke 110 made of an iron plate and the coils 118 are wound in a whirlpool shape on the vibrating membrane 114, the thickness is increased, which makes it difficult to apply the flat speaker to portable instruments, etc.

### SUMMARY OF THE INVENTION

The present invention is contrived to solve the aforementioned problems and it is an object of the present invention to provide a system module allowing decrease in size and thickness by forming a plurality of devices on a sheet of a film member, each device including an actuator or a part of an actuator.

According to a first aspect of the present invention for accomplishing the aforementioned object, there is provided a system module comprising a plate-shaped film member, wherein the plate-shaped film member includes first and second film members stacked to oppose each other with a predetermined gap therebetween, an actuator or a part of an actuator is formed in the predetermined gap, and one of the first and second film member is provided with one or more actuators or a part of the one or more actuators and with one or more devices other than the one or more actuators.

In a second aspect of the present invention for accomplishing the aforementioned object, one of the first and second film members may be mounted with the one or more devices driving the one or more actuators and may be formed with a circuit pattern connecting the one or more devices to the one or more actuators.

In a third aspect of the present invention for accomplishing the aforementioned object, one of the first and second film members may be formed with one of a coil and a magnet which is a part of the one or more actuators and the film member formed with the coil may be vibrated by applying current to the coil.

In a fourth aspect of the present invention for accomplishing the aforementioned object, the one or more actuators may comprise the coil formed on one of the first and second film members and a magnet formed on the other of the first and second film members opposing the coil.

In a fifth aspect of the present invention for accomplishing the aforementioned object, the coil may be formed in a ring shape on the first film member and the magnet may be formed on the second film member at a position opposing an inner circumferential portion of the ring-shaped coil with a yoke therebetween.

In a sixth aspect of the present invention for accomplishing the aforementioned object, in the one or more actuators, a vibrating membrane made of a predetermined-area electrode which is a part of the one or more actuators may be formed on one of the first and second film members, a back plate may be formed in the predetermined gap opposing the vibrating membrane with a dielectric film therebetween, and capacitance between the vibrating membrane and the back plate may change by vibration of one of the first and second film members and resultant vibration of the vibrating membrane.

In a seventh aspect of the present invention for accomplishing the aforementioned object, in the one or more actuators, a driven member comprising one of a coil and a magnet may be formed on one of the first and second film members, a driving member comprising one of a magnet and a coil may be provided in the predetermined gap opposing the driven member, and the driving member can rotate in a horizontal direction parallel to the first film member by applying current to the coil.

In an eighth aspect of the present invention for accomplishing the aforementioned object, the driving member may be formed at one end of an arm member which can freely rotate in the horizontal direction and a circuit component may be provided at the other end of the arm member.

In a ninth aspect of the present invention for accomplishing the aforementioned object, the one or more actuators, in which the driving member is formed at one end of an arm member which can freely rotate in the horizontal direction and a specular reflecting surface is formed at the other end of the arm member, may be provided at a branch point of an optical path guiding light.

In a tenth aspect of the present invention for accomplishing the aforementioned object, the optical path may be surrounded with a reflecting film.

In an eleventh aspect of the present invention for accomplishing the aforementioned object, a light waveguide which can guide incident light through internal reflection may be provided in the optical path.

In a twelfth aspect of the present invention for accomplishing the aforementioned object, a flow channel through which fluid can flow may be formed in the predetermined gap between the first and second film members, and at least an inhalant valve which can inhale the fluid from the flow channel with a pump may be formed in the first film member adjoining to the flow channel.

In a thirteenth aspect of the present invention for accomplishing the aforementioned object, the pump may have a pump chamber with a size including the inhalant valve and a discharge valve which can discharge the fluid inhaled through the inhalant valve, and the pump can inhale the fluid into the pump chamber through the inhalant valve and discharge the fluid from the pump chamber through the discharge valve.

According to the present invention, since first and second film members stacked to oppose each other with a predetermined gap therebetween are provided, an actuator or a part of an actuator is formed in the predetermined gap, and one of the first and second film members is provided with one or more actuators or a part of the one or more actuators and with one or more devices other than the one or more actuators, it is possible to reduce the number of components and thus to improve an assembling ability.

Since one of the first and second film members is mounted with the one or more devices driving the one or more actuators and is formed with a circuit pattern connecting the one or more devices to the one or more actuators, it is possible to further reduce the number of components and to improve the assembling ability of an apparatus employing the system module according to the present invention.

Since one of the first and second film members is formed with one of a coil and a magnet which is a part of the one or more actuators and the film member formed with the coil is vibrated by applying current to the coil, it is possible to provide a thin flat speaker or a vibration generator which can be mounted on a mobile phone, etc.

Since the one or more actuators comprise the coil formed on one of the first and second film members and a magnet formed on the other of the first and second film members to oppose the coil, it is possible to securely vibrate the film member formed with the coil.

Since the coil is formed in a ring shape on the first film member and the magnet is formed on the second film member at a position opposing an inner circumferential portion of the ring-shaped coil with a yoke therebetween, it is possible to provide a thinner flat speaker or vibration generator.

Since in the one or more actuators, a vibrating membrane made of a predetermined-area electrode is formed on one of the first and second film members, a back plate is formed in the predetermined gap opposing the vibrating membrane with a dielectric film therebetween, and capacitance between the vibrating membrane and the back plate changes by vibration of one of the first and second film members and resultant vibration of the vibrating membrane, it is possible to provide a thin microphone by converting the change of such capacitance into voice signals, and thus to integrally form a microphone, a vibration generator, and a flat speaker on a sheet of a film member. As a result, it is possible to reduce the number of components and to improve the assembling ability.

Since in the one or more actuators, a driven member comprising one of a coil and a magnet is formed on one of the first and second film members, a driving member comprising one of a magnet and a coil is provided in the predetermined gap opposing the driven member, and the driving member can rotate in a horizontal direction parallel to the first film member by applying current to the coil, it is possible to provide a thin actuator by forming the driven member and the driving member on a film member.

Since the driving member is formed at one end of an arm member which can freely rotate in the horizontal direction and a circuit component is provided at the other end of the arm member, it is possible to provide a thin disk drive unit by providing a circuit component such as a magnetic head to the arm member.

Since the one or more actuators, in which the driving member is formed at one end of an arm member which can freely rotate in the horizontal direction and a specular reflecting surface is formed at the other end of the arm member, are provided at a branch point of an optical path guiding light, it is possible to securely guide light to a desired optical path at the branch point.

Since the optical path is surrounded with a reflecting film, it is possible to guide light incident to the optical path without loss.

Since a light waveguide which can guide incident light through the internal reflection is provided in the optical path, it is possible to guide the incident light without loss.

Since a flow channel through which fluid can flow is formed in the predetermined gap between the first and second film members, and at least an inhalant valve which can inhale the fluid from the flow channel with a pump is formed in the first film member adjoining to the flow channel, a part of a pump and a flow channel can be constituted with a film member, so that it is possible to reduce the number of components of the pump which is a device.

Since the pump has a pump chamber with a size including the inhalant valve and a discharge valve which can discharge the fluid inhaled through the inhalant valve, and the pump can inhale the fluid into the pump chamber through the inhalant valve and discharge the fluid from the pump chamber through the discharge valve, it is possible to further reduce the number of components and to make the pump thinner.

### BRIEF DESCRIPTION OF THE DRAWINGS

FIG. 1 is a plan view illustrating a first embodiment of the present invention.

FIG. 2 is a cross-sectional view illustrating an important part of FIG. 1

FIG. 3 is a diagram illustrating a second embodiment of the present invention.

FIG. 4 is a diagram illustrating the second embodiment of the present invention.

FIG. 5 is a diagram illustrating the second embodiment of the present invention.

FIG. 6 is a diagram illustrating the second embodiment of the present invention.

FIG. 7 is a diagram illustrating the second embodiment of the present invention.

FIG. 8 is a diagram illustrating a third embodiment of the present invention.

FIG. 9 is a diagram illustrating the third embodiment of the present invention.

FIG. 10 is a diagram illustrating a fourth embodiment of the present invention.

FIG. 11 is a diagram illustrating the third embodiment of the present invention.

FIG. 12 is a diagram illustrating a conventional module.

### DESCRIPTION OF THE PREFERRED EMBODIMENT

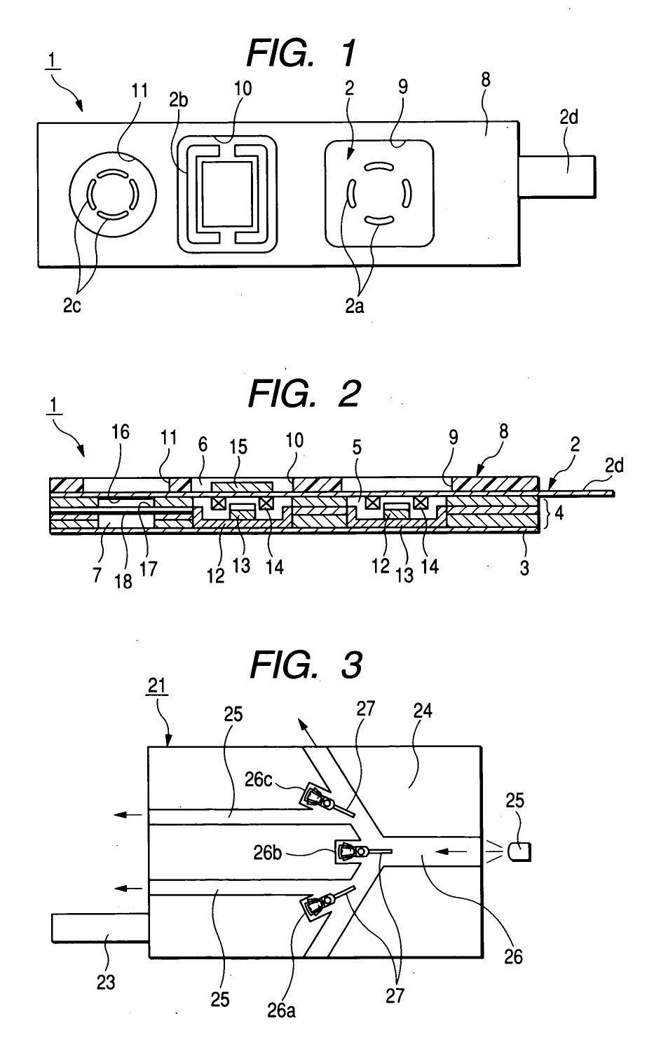

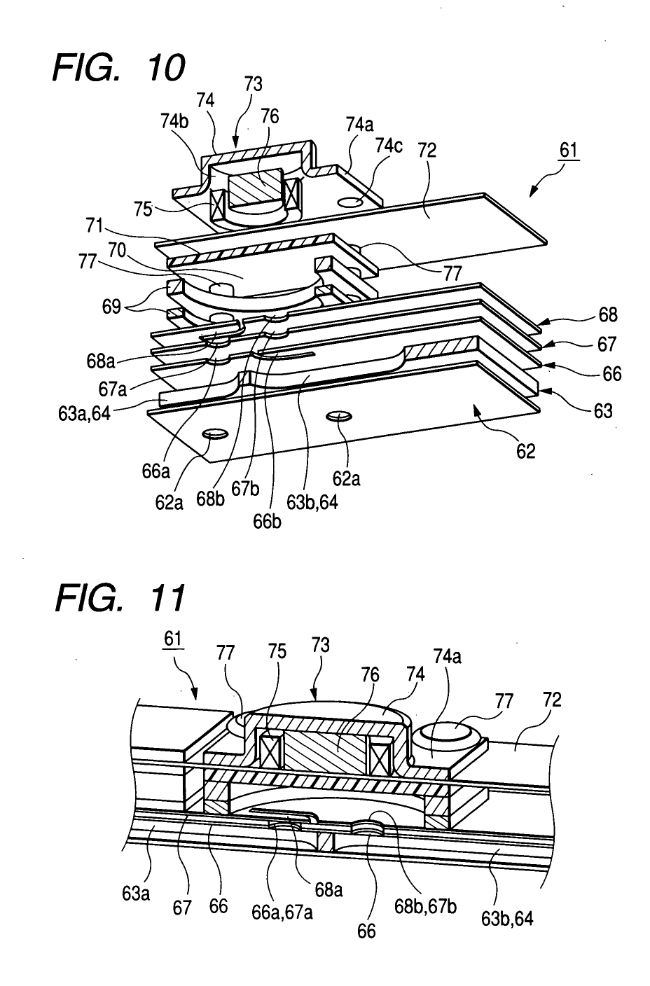

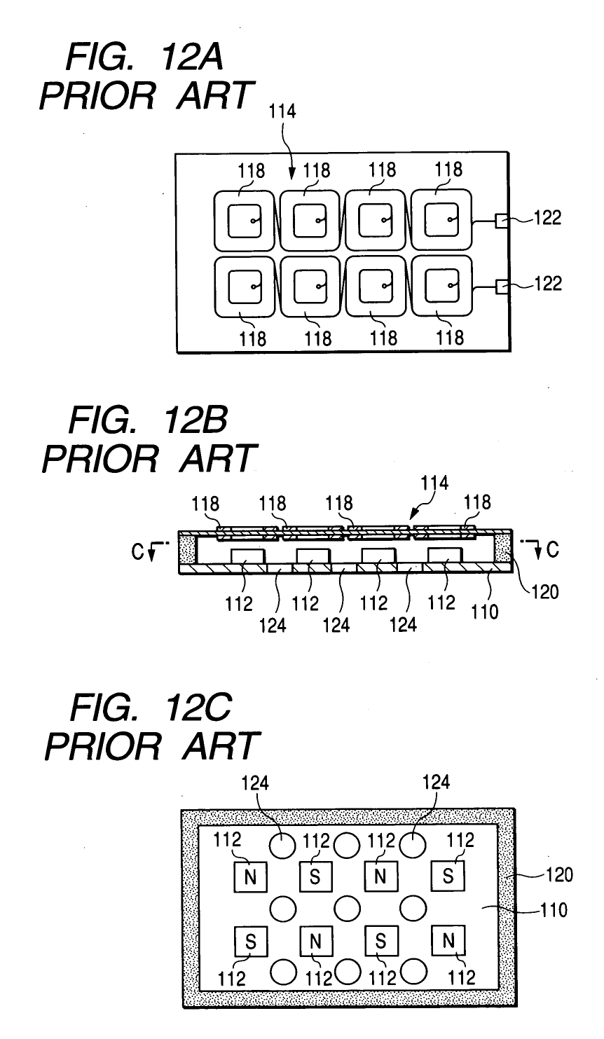

In a system module according to the present invention, a plurality of actuators or a part of an actuator is formed on a sheet of film member thin and flexible. The system module according to the present invention will be now described with reference to the drawings. FIG. 1 is a plan view illustrating a first embodiment of the present invention, FIG. 2 is a cross-sectional view of an important part of FIG. 1, FIGS. 3 to 7 are diagrams illustrating a second embodiment of the present invention, FIGS. 8 and 9 are diagrams illustrating a third embodiment of the present invention, and FIGS. 10 and 11 are diagrams illustrating a fourth embodiment of the present invention.

First, in a system module 1 according to a first embodiment of the present invention, as shown in FIGS. 1 and 2, a first film member 2 is disposed at the upside and a second film member 3 is stacked and disposed at the downside opposing the first film member 2.

Between the first and second film members 2 and 3, for example, first to third gaps 5 to 7 having predetermined gap values are formed with a first spacer 4 which is formed by stacking a plurality of film members.

A second spacer 8 is stacked on the first film member 2. In the second spacer 8, a first opening 9 having an approximately square shape is formed at a portion opposing the first gap 5, a second opening 10 having an approximately rectangular shape is formed at a portion opposing the second gap 6, and a third opening 11 having a circular shape is formed at a portion opposing the third gap 7.

In the first film member 2 exposed from the first opening 9, arc-shaped slits 2a are formed at the outside of a ring-shaped coil 14 to be described later.

In the first film member 2 exposed from the second opening 10, a pair of slits 2b is formed to oppose each other at the outside of a bob 15 to be described.

In the first film member 2 exposed from the third opening 11, slits 2c having an arc shape smaller than the slits 2a formed in the first opening 9 are formed.

In the first to third gaps 5 to 7, an actuator or a part of an actuator is formed, and these devices can be independently driven and controlled.

A device disposed in the first gap 5 is a flat speaker, a yoke 12 made of a magnetic material with a predetermined thickness is mounted on the second film member 3, and a circular magnet 13 made of a permanent magnet is fixed or printed on the yoke 12.

A coil 14 is formed in a ring shape in the first film member 2 opposing the magnet 13 by means of printing, etc., and the magnet 13 is fixed to the yoke 12 opposing the inner circumferential portion of the ring-shaped coil 14.

In the device which is such a flat speaker provided in the fist gap 5, magnetic flux generated by applying predetermined current to the coil 14 acts on magnetic flux of the magnet, so that the first film member 2 provided with the coil 14 vibrates. The vibration of the first film member 2 emits sound.

The device provided in the second gap 6 is a vibration generator, the same yoke 12, magnet 13, and coil 14 as the flat speaker are provided between the first and second film member 2 and 3, and a bob 15 having a predetermined weight is fixed to the upper surface of the first film member 2.

Then, by applying current to the coil, the first film member 2 vibrates, and the bob 15 vibrates in response to the vibration. The vibration of the bob 15 vibrates the whole system module 1.

As a result, by building the system module according to the present invention in a portable telephone, the mobile telephone can vibrate in a manner mode.

The device provided in the third gap 7 is a microphone, a vibrating membrane 16 made of a predetermined-area electrode is formed on the inner surface of the first film member 2 opposing the second film member 3 by means of printing or deposition, and a back plate 18 is formed at a portion opposing the vibrating membrane 16 with a gap with a dielectric film 17 therebetween by means of printing or deposition.

When air vibrates due to utterance of a person, the vibration is transferred to the vibrating membrane 16 through the first film member 2. The capacitance with the back plate 18 through the dielectric film 17 is varied due to the vibration of the vibrating membrane 16. Then, the variation of capacitance can be converted into sound signals and transmitted.

An example where the system module 1 according to the first embodiment of the present invention is applied to, for example, a mobile telephone (not shown) will be described. When the system module 1 according to the present invention is fitted into a case of the mobile telephone such that the first opening 9 is located at a speaker portion of the mobile telephone and the third opening 11 is located at a microphone portion of the mobile telephone, the vibration generator formed in the second opening 10 is located at the approximately central portion of the case.

The first film member 2 is formed to have an area greater than that of the second spacer 8 (not shown), and this portion is provided with one or more devices (not shown) other than the actuators or a part of the actuators formed in the first to third gaps 5 to 7.

The device may include circuit components such as LED, switches, actuators other than the flat speaker, the microphone, and the vibration generator.

When the device is a circuit component as a switch, a circuit pattern (not shown) connecting the circuit component to the actuators such as the flat speaker, the microphone, and the vibration generator is printed on the first film member 2, and the circuit pattern is drawn out as a terminal portion 2d.

An example where a system module 21 according to a second embodiment of the present invention is applied to a light distribution system shown in FIGS. 3 to 5 will be described. In the light distribution system, a spacer 24 formed by stacking a plurality of films is provided between a first and second film members 22 and 23 made of a transparent film, and the spacer 24 forms an optical path 26 which has a predetermined gap and guides light from a light source 25.

Branch points 26a, 26b, and 26c are formed in the optical path 26, and each of the branch points 26a, 26b, and 26c is provided with an actuator 27 including a light distribution system which can switch the direction of light by blocking the optical path.

In each actuator 27, a first yoke 28 made of a magnetic material is provided on the lower surface of the second film member 23 at which each of the branch points 26a, 26b, and 26c is formed.

A magnet 29 made of a permanent magnet as a driven member is provided on the second film member 23 opposing the first yoke 28 by means of printing or bonding. A second yoke 30 having the same material and shape as the first yoke 28 is formed on the first film member 22 opposing the magnet 29. The first and second yokes 28 and 30 are electrically connected to each other through a connection member not shown.

A coil 31 as a driving member is provided in a gap between the magnet 29 and the second yoke 30, and the coil 31 is formed at one end (the left side in the figure) of an arm member 32 which can freely rotate in a horizontal direction parallel to the first and second film members 22 and 23. A specular reflecting surface 32a is formed at the other end (the right side in the figure) of the arm member 32 by means of plating, etc.

The arm member 32 is supported such that it can freely rotate in the arrow directions A and B about a support axis 33. The support axis 33 is supported by a bearing 34 provided on the lower surface of the second film member 23.

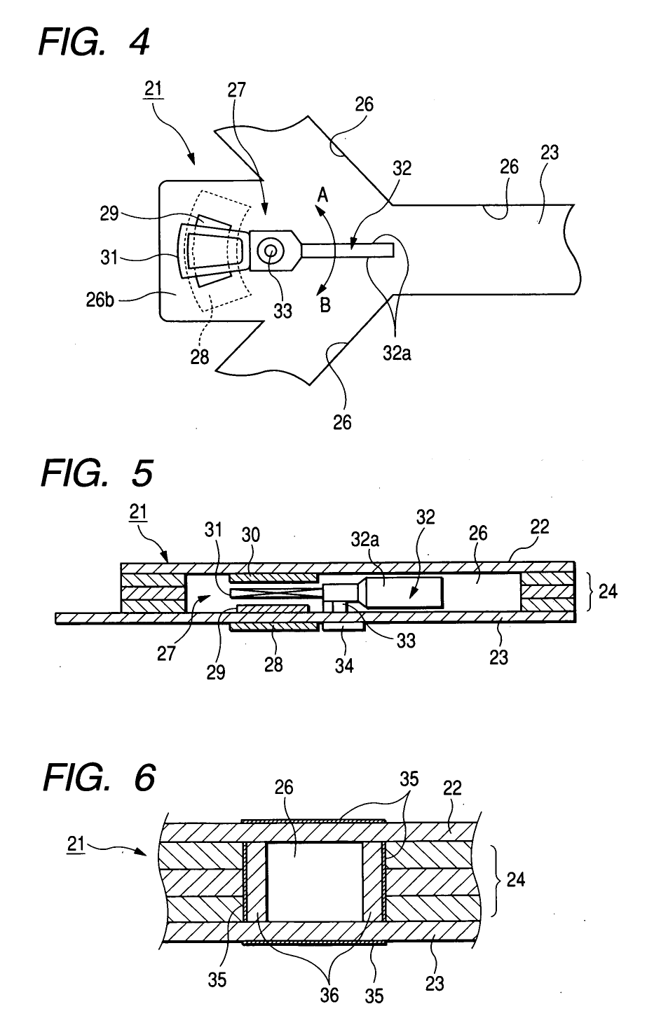

The actuator 27 having the aforementioned structure is provided at the respective branch points 26a, 26b, and 26c of the optical path 26. Then, when the arm member 32 shown in FIG. 4 is rotated in the arrow direction A, the upper optical path in the figure is blocked by the arm member 32. Accordingly, the light from the light source 25 can be guided to the lower optical path 26 in the figure by the reflecting surface 32a formed on the arm member 32.

In the second embodiment of the present invention, it has been described that the magnet 29 is formed on the second film member 23 and the coil 31 is formed in the arm member 32. However, the magnet 29 may be formed in the arm member 32 and the coil 31 may be formed on the second film member 23.

In the optical path 26, as shown in FIG. 6, reflecting films 35 printed with mirror ink are formed at the outsides of the first and second film members 22 and 23 in which the optical path 26 is formed. Transparent films 36 are bonded to the end surfaces of the spacer 24 which are inner surfaces of the optical path 26 with an adhesive, etc., and reflecting films 35 are formed on the transparent films 36.

As a result, since all the sides of the optical path 26 are covered with the reflecting films, the light incident to the optical path 26 from the light source 25 is guided into the optical path 26 without loss, and can be emitted externally with high efficiency.

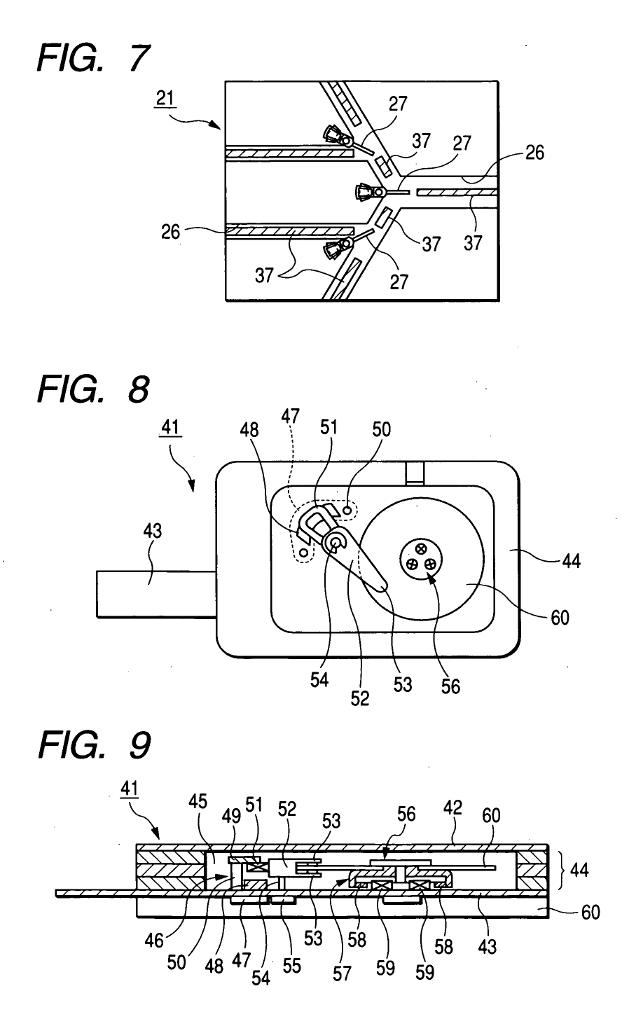

When the reflecting films 35 are not formed, as shown in FIG. 7, a light waveguide 37 may be provided in the optical path 26, so that the incident light can be internally reflected and guided approximately by 100%.

An example where a system module 41 according to a third embodiment of the present invention is applied to a hard disk drive system shown in FIGS. 8 and 9 will be described. In the hard disk drive system, a spacer 44 is provided between first and second film member 42 and 43, and a gap having a predetermined size is formed by the spacer 44.

A voice coil motor 46 as an actuator is provided in the gap 45. In the voice coil motor 46, a first yoke 47 made of a magnetic material is provided on the lower surface of the second film member 43.

A magnet 48 as a driven member is printed on a portion of the second film member 43 opposing the first yoke 47. A second yoke 49 is provided on a portion of the first film member 42 opposing the magnet 48.

The first and second yokes 47 and 49 are electrically connected to each other through a connection member 50 having a rod shape, a coil 51 as a driving member is provided in a gap between the magnet 48 and the second yoke 49, and the coil 51 is formed at one end (the left side in the figure) of an arm member 52 which can freely rotate in the horizontal direction.

A magnetic head 53 as a circuit component is attached to the other end (the right side in the figure) of the arm member 52.

The arm member 52 can freely rotate about a support axis 54, and the support axis 54 is supported by a bearing 55 provided on the lower surface of the second film member 43.

A disk driving member 56 as another actuator is provided on the second film member 43 at the right side of the actuator 46.

The disk driving member 56 comprises a turn table 57 and a spindle motor including a magnet 58 and a coil 59 attached to the inner circumferential surface of the turn table 5.

The second film member 43 mounted with the actuator 46 and the disk driving member 56 is fitted to a resin substrate 60, thereby preventing the bending thereof.

By applying current to the coil 51 of the voice coil motor 46 in a state the magnetic head 53 of the voice coil motor 46 sandwiches a disk 60 mounted on the turn table 57, the arm member 52 rotates by a predetermined angle, and thus the magnetic head 53 performs seeking operation.

In the system module 41 according to the third embodiment having the aforementioned structure, since the voice coil motor 46 and the disk driving member 56 as plural actuators are mounted on the second film member 43 to form a unified body, it is possible to reduce the number of components and to decrease the thickness thereof.

An example where a system module 61 according to a fourth embodiment of the present invention is applied to a pump shown in FIGS. 10 and 11 will now be described. A second film member 62 made of a thin film is provided at the lowermost portion. Support holes 62a having a predetermined size are formed at a predetermined pitch in the second film member 62.

A first spacer 63 made of a resin material, etc. and having a predetermined thickness is stacked and mounted on one surface (the upper surface in the figure) of the second film member 62, a first groove portion 63a and a second groove portion 63b having a slit shape are formed in the first spacer 63, and a flow channel 64 is formed by the first and second groove portions 63a and 63b, so that fluid is guided into and flows through the flow channel.

A first film member 66 is stacked and mounted on the first spacer 63, and the first spacer 63 is inserted in a sandwich shape between the second and first film members 62 and 66, thereby forming the flow channel 64 with the first and second groove portions 63a and 63b.

In the first film member 66, a hole 66a is formed at a portion where the first groove portion 63 is positioned, and a second valve 66b having a tongue shape which can be elastically deformed is formed at a portion where the second groove portion 63b is positioned.

The second spacer 67 is stacked and mounted on the first film member 66. In the second spacer 67, a first opening 67a is formed at a position opposing the hole 66a, and a second opening 67b is formed at a position opposing the second valve 66b of the first film member 66.

A sheet member 68 of a film shape is stacked and disposed with approximately the same thickness as the first film member 6 on the second spacer 67.

In the sheet member 68, a first valve 68a having a tongue shape which can elastically deformed is formed at a position opposing the first opening 67a of the second spacer 67, and a hole 68b is formed at a portion opposing the second opening 67b.

Two sheets of pump spacers 69 having a rectangular shape are stacked on a portion of the sheet member 68 opposing the first valve 68a and the hole 68b.

A pump chamber 70 with a size including the first valve 68a and the hole 68b is formed in an approximately circle shape at the inside of the pump spacer 69.

The upside of the pump chamber 70 is provided with a diaphragm made of rubber which can be elastically deformed, thereby closely sealing the pump chamber 70.

An FPC (flexible printed circuit board) 72 on which wiring patterns (not shown) are formed are stacked and disposed on the diaphragm 71, and a driving unit of the pump 73 is formed on the pump chamber 70 with the FPC 72 and the diaphragm 71 therebetween.

The driving unit of the pump 73 has a yoke 74 of which the outer circumferential portion is made of a magnetic material, a collar portion 74a having an approximately rectangular shape is formed in the yoke 74, and the central portion of the collar portion 74a is protruded upwardly, thereby forming a concave portion 74b having a predetermined height.

Support holes 74c are formed at four corners of the collar portion 74a.

A hollow coil 75 is provided at the inside of the concave portion 74b, and the coil 75 is attached to the FPC 72 with an adhesive, etc. A magnet 76 made of a permanent magnet is provided at the hollow inside of the coil 75, and the magnet 76 is attached to the ceiling surface of the concave portion 74b formed in the yoke 74 with an adhesive, etc.

As a result, magnetic flux generated by applying AC current with a predetermined frequency to the coil 75 acts on magnetic flux of the magnet 76, thereby moving the coil 75 upward and downward.

Accordingly, the FPC 72 and the diaphragm 71 vibrate, so that the inside of the pump chamber 70 can be contracted and expanded.

In the pump 73, rod-shaped rivets 77 are inserted into the support holes 74c formed in the collar portion 74a of the yoke 74, the rivets 77 pass through the support holes (not shown) formed in the FPC 72, the pump spacer 69, the sheet member 68, the second spacer 67, the first film member 66, and the first spacer 63, respectively, and the end portions thereof are protruded by a predetermined size from the support holes 62a of the second film member 62.

The lower side of the second film member 62 is provided with a plate-shaped sandwiching member (not shown) made of a metal plate, and by fastening both ends of the rivets 77 protruded from the support holes 74c formed in the sandwiching member and the collar portion 74a of the yoke 74, the flow channel 64 and the pump chamber 70 are closely sealed.

In the system module 61 according to the fourth embodiment of the present invention, since the flow channel 64 is formed between the first and second film members 66 and 62 and the valve 66b constituting a part of the pump 73 as an actuator is formed in the first film member 66, it is possible to make the pump 73 thinner.

Although not described in the embodiments of the present invention, the area of one of the first and second film members is formed larger. The larger-formed portion is mounted with a circuit component such as a switch, etc. of, for example, a mobile telephone, etc. which can drive the actuator or a part of the actuator of the system module according to the present invention, and a circuit pattern connecting the circuit component to the actuator or a part of the actuator of the system module according to the present invention is formed in the larger-formed portion.

As a result, it is possible to reduce the number of components and thus to improve an assembling ability.

1. A system module comprising a plate-shaped film member,
wherein the plate-shaped film member includes first and second film members stacked to oppose each other with a predetermined gap therebetween, an actuator or a part of an actuator is formed in the predetermined gap, and one of the first and second film members is provided with one or more actuators or a part of the one or more actuators and with one or more devices other than the one or more actuators.

2. The system module according to claim 1, wherein one of the first and second film members is mounted with the one or more devices driving the one or more actuators, and is formed with a circuit pattern connecting the one or more devices to the one or more actuators.

3. The system module according to claim 1, wherein one of the first and second film members is formed with one of a coil and a magnet which is a part of the one or more actuators and the film member formed with the coil is vibrated by applying current to the coil.

4. The system module according to claim 3, wherein the one or more actuators comprise the coil formed on one of the first and second film members and a magnet formed on the other of the first and second film members opposing the coil.

5. The system module according to claim 4, wherein the coil is formed in a ring shape on the first film member and the magnet is formed on the second film member at a position opposing an inner circumferential portion of the ring-shaped coil with a yoke therebetween.

6. The system module according to claim 1, wherein in the one or more actuators, a vibrating membrane made of a predetermined-area electrode which is a part of the one or more actuators is formed on one of the first and second film members, a back plate is formed in the predetermined gap opposing the vibrating membrane with a dielectric film therebetween, and capacitance between the vibrating membrane and the back plate is made to change by vibration of one of the first and second film members and resultant vibration of the vibrating membrane.

7. The system module according to claim 1, wherein in the one or more actuators, a driven member comprising one of a coil and a magnet is formed on one of the first and second film members, a driving member comprising one of a magnet and a coil is provided in the predetermined gap opposing the driven member, and the driving member can rotate in a horizontal direction parallel to the first film member by applying current to the coil.

8. The system module according to claim 7, wherein the driving member is formed at one end of an arm member which can freely rotate in the horizontal direction and a circuit component is provided at the other end of the arm member.

9. The system module according to claim 7, wherein the one or more actuators, in which the driving member is formed at one end of an arm member which can freely rotate in the horizontal direction and a specular reflecting surface is formed at the other end of the arm member, are provided at a branch point of an optical path guiding light.

10. The system module according to claim 9, wherein the optical path is surrounded with a reflecting film.

11. The system module according to claim 9, wherein a light waveguide which can guide incident light through internal reflection is provided in the optical path.

12. The system module according to claim 1, wherein a flow channel through which fluid can flow is formed in the predetermined gap between the first and second film members, and at least an inhalant valve which can inhale the fluid from the flow channel with a pump is formed in the first film member adjoining to the flow channel.

13. The system module according to claim 12, wherein the pump has a pump chamber with a size including the inhalant valve and a discharge valve which can discharge the fluid inhaled through the inhalant valve, and the pump can inhale the fluid into the pump chamber through the inhalant valve and discharge the fluid from the pump chamber through the discharge valve.

14. The system module according to claim 2, wherein one of the first and second film members is formed with one of a coil and a magnet which is a part of the one or more actuators and the film member formed with the coil is vibrated by applying current to the coil.

15. The system module according to claim 14, wherein in the one or more actuators, a vibrating membrane made of a predetermined-area electrode which is a part of the one or more actuators is formed on one of the first and second film members, a back plate is formed in the predetermined gap opposing the vibrating membrane with a dielectric film therebetween, and capacitance between the vibrating membrane and the back plate is made to change by vibration of one of the first and second film members and resultant vibration of the vibrating membrane.

16. The system module according to claim 15, wherein in the one or more actuators, a vibrating membrane made of a predetermined-area electrode which is a part of the one or more actuators is formed on one of the first and second film members, a back plate is formed in the predetermined gap opposing the vibrating membrane with a dielectric film therebetween, and capacitance between the vibrating membrane and the back plate is made to change by vibration of one of the first and second film members and resultant vibration of the vibrating membrane.

17. The system module according to claim 2, wherein in the one or more actuators, a vibrating membrane made of a predetermined-area electrode which is a part of the one or more actuators is formed on one of the first and second film members, a back plate is formed in the predetermined gap opposing the vibrating membrane with a dielectric film therebetween, and capacitance between the vibrating membrane and the back plate is made to change by vibration of one of the first and second film members and resultant vibration of the vibrating membrane.

18. The system module according to claim 2, wherein in the one or more actuators, a driven member comprising one of a coil and a magnet is formed on one of the first and second film members, a driving member comprising one of a magnet and a coil is provided in the predetermined gap opposing the driven member, and the driving member can rotate in a horizontal direction parallel to the first film member by applying current to the coil.

19. The system module according to claim 18, wherein the driving member is formed at one end of an arm member which can freely rotate in the horizontal direction and a circuit component is provided at the other end of the arm member.

20. The system module according to claim 18, wherein the one or more actuators, in which the driving member is formed at one end of an arm member which can freely rotate in the horizontal direction and a specular reflecting surface is formed at the other end of the arm member, are provided at a branch point of an optical path guiding light.

21. The system module according to claim 20, wherein the optical path is surrounded with a reflecting film.

22. The system module according to claim 20, wherein a light waveguide which can guide incident light through internal reflection is provided in the optical path.

23. The system module according to claim 2, wherein a flow channel through which fluid can flow is formed in the predetermined gap between the first and second film members, and at least an inhalant valve which can inhale the fluid from the flow channel with a pump is formed in the first film member adjoining to the flow channel.

24. The system module according to claim 23, wherein the pump has a pump chamber with a size including the inhalant valve and a discharge valve which can discharge the fluid inhaled through the inhalant valve, and the pump can inhale the fluid into the pump chamber through the inhalant valve and discharge the fluid from the pump chamber through the discharge valve.
